(19) United States
(12) Patent Application Publication
(10) Pub. No.: US 2014/0284100 A1
(43) Pub. Date: Sep. 25, 2014

(54) WIRE HARNESS

(71) Applicant: YAZAKI CORPORATION, Tokyo (JP)

(72) Inventors: Hidehiro Ichikawa, Shizuoka (JP); Makoto Katsumata, Shizuoka (JP)

(73) Assignee: YAZAKI CORPORATION, Tokyo (JP)

(21) Appl. No.: 14/353,566

(22) PCT Filed: Nov. 2, 2012
(86) PCT No.: PCT/JP2012/079045

§ 371 Date: Apr. 23, 2014

(30) Foreign Application Priority Data
Nov. 4, 2011 (JP) 2011-241945

(51) Int. Cl. H01B 9/00

(52) U.S. Cl. CPC H01B 9/006
USPC 174/70 R

(57) ABSTRACT

A wire harness capable of improving manufacturability and handleability is provided. A wire harness 9 is means for electrically connecting a front inverter unit 4 to a battery 5, and is configured to include two high-voltage electric wires, and a shielding member 20 with which the two high-voltage electric wires are collectively covered, the shielding member 20 for shielding the high-voltage electric wires. The shielding member 20 is configured to be divided into plural pieces in a cabling direction of the wire harness 9. Also, in the shielding member 20, each of the divided pieces has an independent shielding function. The shielding member 20 is divided into the plural pieces so as to have plural braid shielding members 26 to 32 and plural conductive pipe shielding members 33 to 38.

### TECHNICAL FIELD

The present invention relates to a high-voltage wire harness cabled to a mobile unit such as a vehicle.

### BACKGROUND ART

A high-voltage wire harness is used for electrically connecting devices of a hybrid vehicle or an electric vehicle, that is, the devices such as a motor unit, an inverter unit or a battery.

A wire harness disclosed in the following PTL 1 is configured to include three electric wires for making electrical connection between devices, a main shielding part for receiving the three electric wires over most of the whole length of the electric wires, and a sub-shielding part with which the three electric wires extending from the end of the main shielding part are covered. The wire harness is constructed so that a cabling path is very long depending on an installation position of the device.

Each of the distal ends of the three electric wires is provided with a terminal fitting. The terminal fitting is connected to a connection disposed in a predetermined position of the device body by, for example, bolting by being inserted into a shield case of the device together with the distal end of the electric wire after manufacture of the wire harness.

One long metal pipe having conductivity is used in the main shielding part. An inside diameter of the main shielding part is formed in the size in which only the three electric wires can be inserted in order to reduce a diameter of this main shielding part.

The sub-shielding part is configured to include a braid formed in a tubular shape, a shield shell fixed to one end of this braid, and a connecting pipe fixed to the other end of the braid. The shield shell is formed as the portion connected and fixed to the shield case of the device.

The braid and the shield she are fixed by overlapping the braid and the shield shell and arranging a shield ring on the overlap portion and then crimping the shield ring. Such fixing is also adopted in fixing between the braid and the connecting pipe. That is, the braid and the connecting pipe are fixed by overlapping the braid and the connecting pipe and arranging a crimp ring on the overlap portion and then crimping the crimp ring.

A metal pipe with the same inside diameter and the same material as the main shielding part is used in the connecting pipe. The connecting pipe is formed so that the length becomes remarkably shorter than that of the main shielding part. The connecting pipe is fixed by welding after the end of the connecting pipe is matched with the end of the main shielding part.

The configuration and the structure described above show that the wire harness includes a very long shielding member since the sub-shielding part is integrated with the main shielding part by welding as described above.

### CITATION LIST

### Patent Literature

[PTL 1] Japanese Patent Publication No. JP-A-2004-171952

### SUMMARY OF INVENTION

### Technical Problem

Incidentally, in the conventional wire harness described above, the shielding member is made by integrating the sub-shielding part with the main shielding part by welding and is very long, which results in the fact that manufacture of the wire harness including such a long shielding member has a problem of low manufacturability.

Moreover, in the conventional wire harness described above, the whole length must be manufactured in a very long state, which results in the fact that the wire harness has a problem of low handleability for manufacture. Also, in the conventional wire harness described above, the main shielding part which occupies most of the shielding member is long and hard, so that the wire harness has a problem of low manufacturability or handleability for manufacture.

The invention has been implemented in view of the circumstances described above, and a problem of the invention is to provide a wire harness capable of improving manufacturability and handleability.

### Solution to Problem

According to one aspect of the present invention, there is provided (1) a wire harness including one or plural conducting paths, and a shielding member with which said one or plural conducting paths are covered, the shielding member divided into plural pieces in a cabling direction, wherein each of the plural pieces in the shielding member has a grounded part

According to the invention having such a feature, the shielding member with which the one or plural conducting paths are covered is divided into the plural pieces in the cabling direction of the wire harness. Also, each of the plural divided pieces in the shielding member has the grounded part. In manufacture of the wire harness, the shielding member is divided and is not in a simply long state, so that it becomes easy to manufacture the wire harness. Also, the shielding member is divided and is not in the simply long state, so that it becomes easy to handle the wire harness at the time of manufacture. According to the invention, each of the plural divided pieces in the shielding member has the grounded part, so that a shielding function can be fulfilled independently even in a divided state.

In the wire harness as described above, (2) the shielding member divided into the plural pieces may include a shielding member made of a braid or metal foil, and a shielding member made of a conductive pipe, and the shield member made of the conductive pipe may have a fixing member for fixing the shielding member made of the conductive pipe to a conductive wire harness cabling target, the fixing member being combined with the grounded part.

According to the invention having such a feature, in the case of the shielding member made of the braid or the metal foil, the braid or the metal foil has flexibility, so that flexibility can be given to the portion of the wire harness in which the braid or the metal foil is disposed. On the other hand, in the case of the shielding member made of the conductive pipe, for example, when a metal pipe is used as the conductive pipe, the wire harness can be formed in the shape along a predetermined cabling path by bending this metal pipe. In the wire harness, when the shielding member made of the conductive pipe is fixed to the wire harness cabling target, grounding is completed simultaneously with this fixing.

In the wire harness as described above, (3) the shielding member made of the braid or the metal foil and the shielding member made of the conductive pipe are arranged with ends of the shielding member made of the braid or the metal foil and the shielding member made of the conductive pipe lapped mutually.

According to the invention having such a feature, the end of the shielding member made of the conductive pipe is lapped on the end of the shielding member made of the braid or the metal foil to arrange the shielding members, so that the one or plural conducting paths can be covered with the shielding member more surely.

### Advantageous Effects of Invention

According to the above invention described in the above (1), the shielding member is divided into the plural pieces and each of the plural pieces has the shielding function independently, so that it is unnecessary to manufacture the wire harness by a conventional shielding member in a simply long state. Therefore, the invention has an effect capable of improving more manufacturability or handleability for manufacture of the wire harness than ever before.

In addition to the effect of (1), the invention described in the above (2) further has the following effect. That is, the invention has the effect capable of providing the wire harness with flexibility in the case of the shielding member made of the braid or the metal foil and connecting to ground simultaneously with fixing to the wire harness cabling target in the case of the shielding member made of the conductive pipe.

In addition to the effect of (2), the invention described in the above (3) further has the following effect. That is, the invention has the effect capable of improving shielding performance.

### BRIEF DESCRIPTION OF DRAWINGS

FIGS. 1A and 1B are diagrams of a wire harness according to one embodiment of the invention, and FIG. 1A is a schematic diagram of a vehicle, and FIG. 1B is a schematic diagram of the wire harness according to the first embodiment.

FIG. 2 is a configuration diagram according to a first distal end of the wire harness of FIGS. 1A and 1B.

FIG. 3 is a configuration diagram according to an intermediate part of the wire harness of FIGS. 1A and 1B.

FIG. 4 is a configuration diagram according to a second distal end of the wire harness of FIGS. 1A and 1B.

FIGS. 5A and 5B are diagrams according to another example of a wire harness of the invention, and FIG. 5A is a schematic diagram of a vehicle, and

FIG. 5B is a schematic diagram of the wire harness according to the second embodiment.

FIG. 6 is a perspective view according to a state of attachment of a clamp formed as combination with a grounded part.

FIGS. 7A and 7B are diagrams according to a further example of a wire harness of the invention, and FIG. 7A is a schematic diagram of a vehicle, and

FIG. 7B is a schematic diagram of the wire harness according to the third embodiment.

### DESCRIPTION OF EMBODIMENTS

A wire harness includes one or plural conducting paths, and a shielding member with which the conducting paths are covered, the shielding member for shielding the conducting paths. The shielding member is divided into plural pieces in a cabling direction of the wire harness, and each of the plural divided pieces in the shielding member has a grounded part.

### First Embodiment

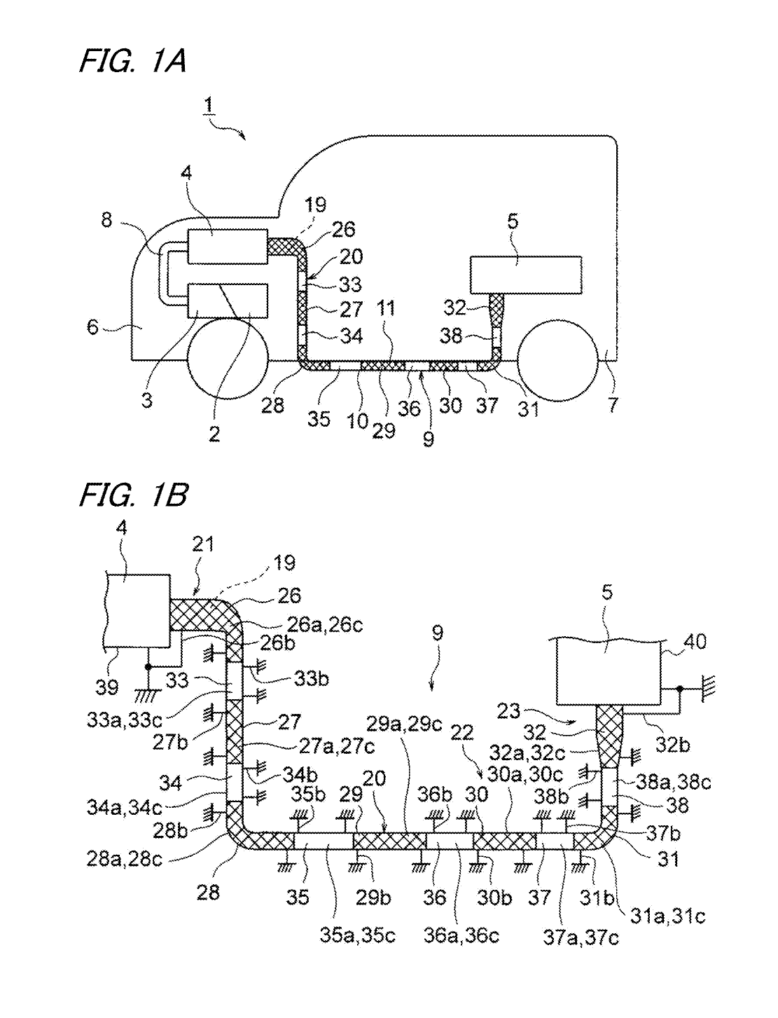

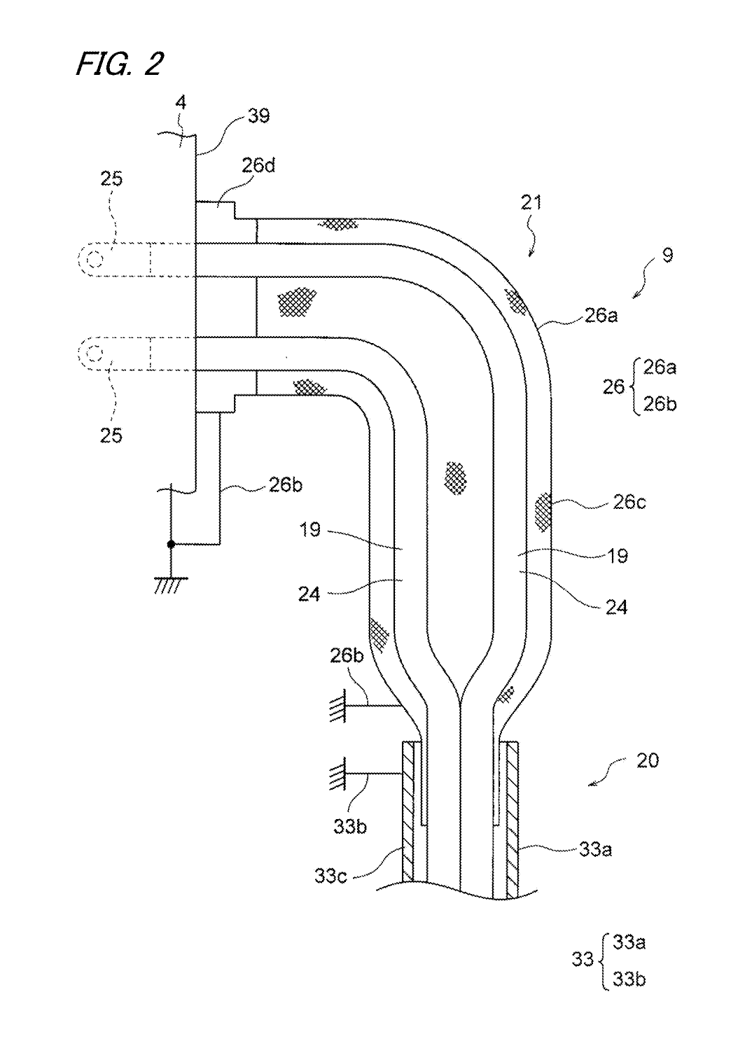

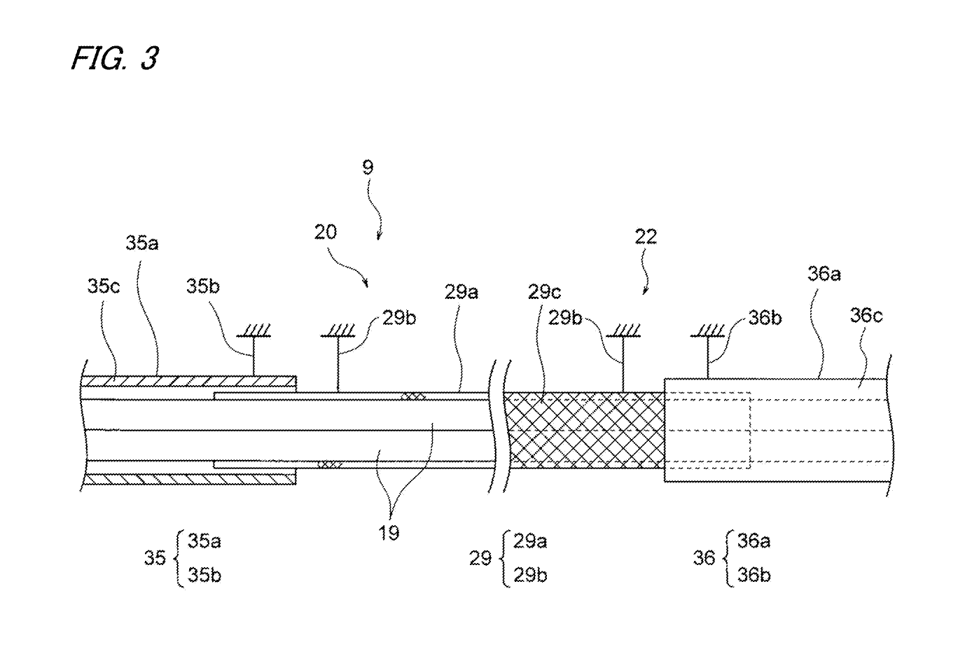

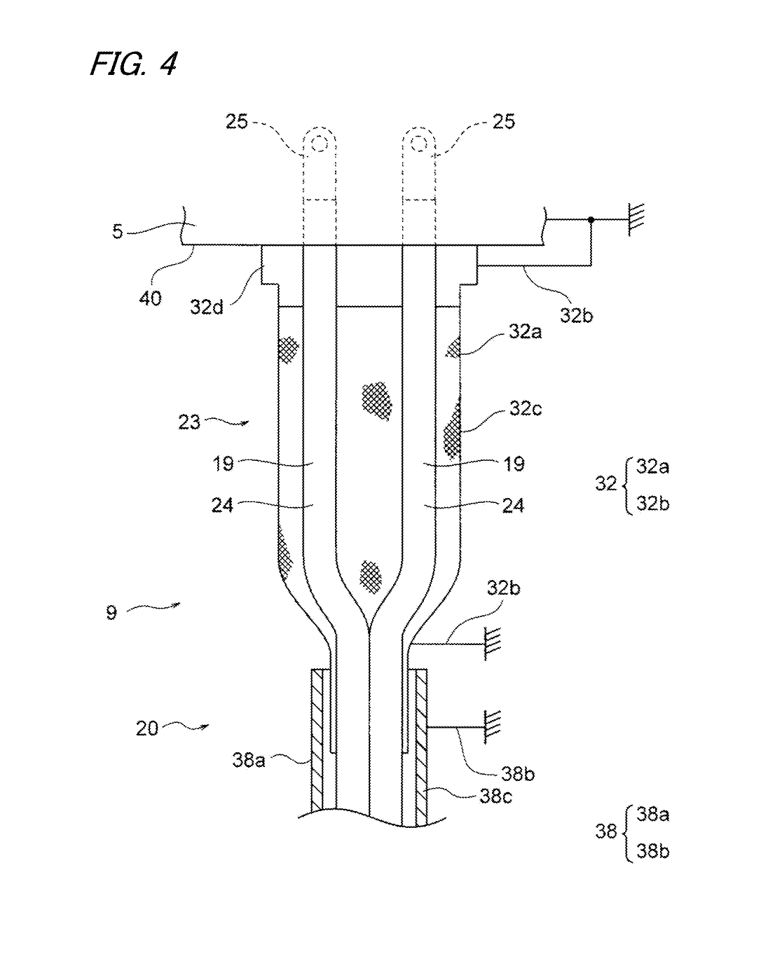

A first embodiment will hereinafter be described with reference to the drawings. FIGS. 1A and 1B are diagrams of a wire harness according to one embodiment of the invention, and FIG. 1A is a schematic diagram of a vehicle, and FIG. 1B is a schematic diagram of the wire harness. Also, FIG. 2 is a configuration diagram according to a first distal end of the wire harness, and FIG. 3 is a configuration diagram according to an intermediate part of the wire harness, and FIG. 4 is a configuration diagram according to a second distal end of the wire harness.

In the present embodiment, an example of adopting the wire harness of the invention in a hybrid vehicle (or may be in an electric vehicle or a general vehicle) shall be given and described.

In FIG. 1A, reference numeral 1 shows a hybrid vehicle. The hybrid vehicle 1 is a vehicle driven by mixing two powers of an engine 2 and a motor unit 3, and is constructed so that electric power from a battery 5 (a battery pack) is supplied to the motor unit 3 through an inverter unit 4. The engine 2, the motor unit 3 and the inverter unit 4 are installed in an engine room 6 of a position having front wheels etc. in the embodiment. Also, the battery 5 is installed in a vehicle rear part 7 having rear wheels etc. (The battery 5 may be installed inside a room of the vehicle present in the rear of the engine room 6).

The motor unit 3 is connected to the inverter unit 4 by a publicly known high-voltage wire harness 8. Also, the inverter unit 4 is connected to the battery 5 by a wire harness 9 of the invention. The wire harness 9 is constructed as a wire harness for high voltage. An intermediate part 10 of the wire harness 9 is cabled to the ground side of a vehicle body underfloor part 11. Also, the wire harness 9 is cabled in substantially parallel along the vehicle body underfloor part 11. The vehicle body underfloor part 11 is a publicly known body and also is the so-called panel member, and a through hole (numeral is omitted) is formed in a predetermined position. The wire harness 9 is inserted into this through hole.

The wire harness 9 is connected to the battery 5 through a junction block (not shown) formed on this battery 5 (shown as one example). The rear end of the wire harness 9 is electrically connected to the junction block by a publicly known method. The front end side of the wire harness 9 is electrically connected to the inverter unit 4 by a publicly known method.

The motor unit 3 includes a motor and a generator in a configuration. Also, the inverter unit 4 includes an inverter and a converter in a configuration. The motor unit 3 is formed as a motor assembly including a shield case. Also, the inverter unit 4 is formed as an inverter assembly including a shield case. The battery 5 is a battery of a Ni-MH system or a Li-ion system, and is formed by modularization. In addition, an electric storage device such as a capacitor can be used. The battery 5 is not particularly limited as long as the battery 5 can be used in the hybrid vehicle 1 or the electric vehicle.

A configuration and structure of the wire harness 9 will hereinafter be described.

In FIGS. 1A and 1B, the wire harness 9 is means for electrically connecting the inverter unit 4 to the battery 5, and is configured to include two high-voltage electric wires 19 (conducting paths), and a shielding member 20 with which the two high-voltage electric wires 19 are collectively covered, the shielding member 20 for shielding the high-voltage electric wires. The shielding member 20 is a characteristic member of the invention, and is configured to be divided into plural pieces in a cabling direction of the wire harness 9. Also, in the shielding member 20, each of the divided pieces has an independent shielding function.

In the following description, the portion of connection to the inverter unit 4 is defined as a first distal end 21. Also, the portion continuous with the first distal end 21 is defined as an intermediate part 22. Further, the portion continuous with the intermediate part 22 and of connection to the battery 5 is defined as a second distal end 23. Furthermore, the side near to the inverter unit 4 is called one end or one hand. Also, the side near to the battery 5 is called the other end or the other hand.

In FIGS. 2 to 4, the high-voltage electric wire 19 is a high-voltage conducting path including a conductor and an insulator (coating) 24, and is formed so as to have a length necessary for electrical connection. The conductor is made of copper or copper alloy, or aluminum or aluminum alloy. The conductor has a conductor structure formed by twisting strands or a bar-shaped conductor structure with a rectangular or circular cross section (for example, a conductor structure with a rectangular or circular single core and in this case, the electric wire itself also has a bar shape), and may have any of the conductor structures.

In addition, the embodiment uses the high-voltage electric wire 19, but is not limited to this high-voltage electric wire 19. That is, for example, a high-voltage conducting path formed by providing a publicly known bus bar with an insulator or a high-voltage coaxial composite conducting path formed by coaxially constructing circuits (n circuits) of n systems in one may be used.

In both of the first distal end 21 and the second distal end 23 in the ends of the high-voltage electric wire 19, the insulators 24 are removed by predetermined lengths. The conductor (not shown) is exposed from this removed portion. A terminal fitting 25 is connected to the exposed conductor. The terminal fitting 25 is formed as the portion connected to a connection (not shown) of the inverter unit 4 and also as the portion connected to a connection (not shown) of the battery 5.

Returning to FIGS. 1A and 1B, the shielding member 20 is divided into the plural pieces as described above. Concretely, the shielding member 20 is divided into the plural pieces so as to have plural braid shielding members 26 to 32 and plural conductive pipe shielding members 33 to 38. In addition, the number of plural braid shielding members 26 to 32 and the number of plural conductive pipe shielding members 33 to 38 in FIG. 1B are shown as one example.

The plural braid shielding members 26 to 32 and the plural conductive pipe shielding members 33 to 38 are alternately disposed in the cabling direction of the wire harness 9. Also, the braid shielding member 26 and the braid shielding member 32 are disposed so as to be positioned in both of the distal ends of the wire harness 9.

The plural braid shielding members 26 to 32 are constructed so as to have flexibility higher than that of the plural conductive pipe shielding members 33 to 38. The plural braid shielding members 26 to 32 having such flexibility are disposed in positions corresponding to the first distal end 21 and the second distal end 23 or positions corresponding to bent parts (bent portions of a cabling path) of the wire harness 9. In addition, the plural braid shielding members 27, 29, 30 to 32 straight illustrated in FIG. 1B shall be bent in, for example, a direction perpendicular to a paper plane.

The shielding member 20 has the plural conductive pipe shielding members 33 to 38 and the plural braid shielding members 26 to 32 and has many flexible portions, so that in such a case, for example, when the wire harness 9 is bent in the portion of the plural braid shielding members 26 to 32 while the wire harness 9 is cabled to the hybrid vehicle 1 after manufacture of the wire harness 9, the wire harness 9 has advantages capable of implementing keeping, conveyance, etc. in a saving in space.

The plural braid shielding members 26 to 32 are configured to include shielding member bodies 26a to 32a with which the two high-voltage electric wires 19 (see FIGS. 2 to 4) are collectively covered, and conductive grounded parts 26b to 32b formed on each of the shielding member bodies 26a to 32a.

As the shielding member bodies 26a to 32a, braids 26c to 32c are used in the embodiment. The braids 26c to 32c are formed in tubular members for electromagnetic shielding (shielding members for measures against electromagnetic waves). Also, the braids 26c to 32c are formed in the length and the size (diameter) in which predetermined ranges of the two high-voltage electric wires 19 (see FIGS. 2 to 4) can be covered. The braids 26c to 32c are formed by using multiple ultrathin strands having conductivity and knitting the strands in a tubular shape.

As the strand, a metallic strand of annealed copper etc., an ultrathin strand made of non-metallic fiber, etc. are given. As the non-metallic fiber, a carbon fiber or a conductive resin fiber in which a conductive material is mixed with a resin material is given. In addition to these strands, for example, a resin strand (strand of PET) for giving abrasion resistance may be mixed.

The grounded parts 26b to 32b are electrically connected and fixed in predetermined positions of the shielding member bodies 26a to 32a. (In the embodiment, two places of one end side and the other end side of each of the shielding member bodies 26a to 32a correspond to the predetermined positions. In addition, the predetermined positions are not limited to the two places.) Such grounded parts 26b to 32b are electrically connected to a wire harness cabling target having conductivity and are formed as the portions capable of cabinet earth or body earth.

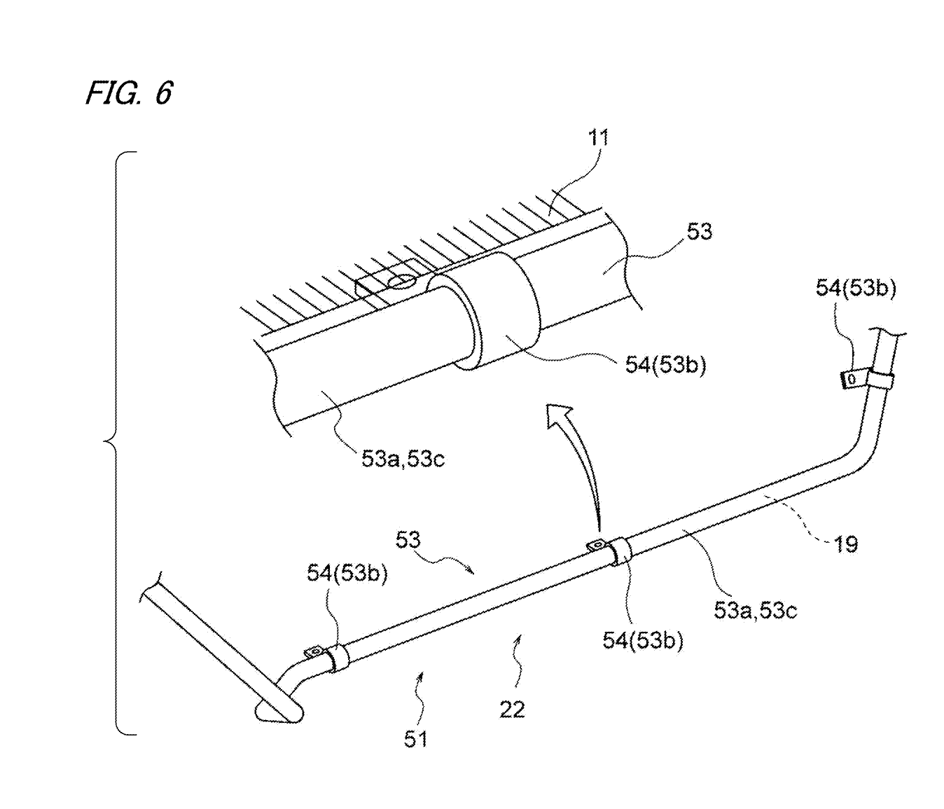

Shapes etc. of the grounded parts 26b to 32b are not particularly limited as long as the cabinet earth or the body earth is enabled. For example, a publicly known earth wire or a structure grounded by extending a part of the braid may be used and also, a member such as a conductive clamp 54 (see FIG. 6) described below may be used. Moreover, the shielding member bodies 26a to 32a may be brought into contact with the adjacent conductive pipe shielding members 33 to 38 to combine grounded parts 33b to 38b (described below) of the conductive pipe shielding members 33 to 38 with the grounded parts 26b to 32b.

In the embodiment, the plural braid shielding members 26 to 32 have a configuration and structure in which the braid shielding members 26 and 32 are basically the same and also the braid shielding members 27 to 31 are basically the same.

In FIG. 2, the braid shielding member 26 corresponding to the first distal end 21 is configured to include the shielding member body 26a and the grounded part 26b. The shielding member body 26a is configured to include the braid 26c and a shield shell 26d formed on one end of this braid 26c, and the shield shell 26d is combined with the grounded part 26b of one end side in the braid shielding member 26. As the shield shell 26d, a publicly known shield shell is used, and the shield shell 26d is formed so as to be able to be connected and fixed to a shield case 39 of the inverter unit 4. In addition, a construction method for crimping a publicly known shield ring is adopted as connection and fixing between the shield shell 26d and the braid 26c (shown as one example).

The other end of the braid 26c is wound by tape having insulation properties (concrete illustration is omitted). The other end of the braid 26c is fixed to the two high-voltage electric wires 19. In the embodiment, a shielding member body 33a (described below) of the conductive pipe shielding member 33 is disposed so as to be lapped on the tape winding portion described above. In addition, in the embodiment, the shielding member body 33a is disposed so as to be lapped on the tape winding portion, so that electrical insulation against the braid 26c is performed.

The insulation may be constructed so as to interpose a ring-shaped member having insulation properties in addition to the tape winding described above. Moreover, there is a method in which the shielding member body 33a (described below) of the conductive pipe shielding member 33 is not lapped on the braid 26c, and in this case, it is preferable that the high-voltage electric wires 19 be not exposed. In addition, lapping arrangement is effective in improving shielding performance since the high-voltage electric wires 19 are not exposed (the same applies to other lapped portions described below).

In FIGS. 1A, 1B and 3, the braid shielding members 27 to 31 (a typical example is shown as, for example, the braid shielding member 29 in FIG. 3) corresponding to the intermediate part 22 are configured to include the shielding member bodies 27a to 31a and the grounded parts 27b to 31b. The shielding member bodies 27a to 31a have the braids 27c to 31c. One end and the other end of the braids 27c to 31c are respectively wound by tape having insulation properties (concrete illustration is omitted). One end and the other end of the braids 27c to 31c are fixed to the two high-voltage electric wires 19.

In the embodiment, shielding member bodies 33a to 38a (described below) of the conductive pipe shielding members 33 to 38 are disposed so as to be lapped on each of the tape winding portions of one end and the other end (insulation is similar to the above).

In FIG. 4, the braid shielding member 32 corresponding to the second distal end 23 is configured to include the shielding member body 32a and the grounded part 32b. The shielding member body 32a is configured to include the braid 32c and a shield shell 32d formed on the other end of this braid 32c, and the shield shell 32d is combined with the grounded part 32b of the other end side in the braid shielding member 32. As the shield shell 32d, a publicly known shield shell is used, and the shield shell 32d is formed so as to be able to be connected and fixed to a shield case 40 of the battery 5. In addition, a construction method for crimping a publicly known shield ring is adopted as connection and fixing between the shield shell 32d and the braid 32c (shown as one example).

One end of the braid 32c is wound by tape having insulation properties (concrete illustration is omitted). One end of the braid 32c is fixed to the two high-voltage electric wires 19. In the embodiment, a shielding member body 38a (described below) of the conductive pipe shielding member 38 is disposed so as to be lapped on the tape winding portion described above. In addition, in the embodiment, the shielding member body 38a is disposed so as to be lapped on the tape winding portion, so that electrical insulation against the braid 32c is performed (insulation is similar to the above).

The outsides of the braid shielding members 27 to 31 as described above are provided with, for example, a publicly known protector as a protective member. (Illustration is omitted. The protector is shown as one example. The protective member may be a publicly known corrugated tube etc.)

Returning to FIGS. 1A and 1B, the plural conductive pipe shielding members 33 to 38 are configured to include the shielding member bodies 33a to 38a with which the two high-voltage electric wires 19 (see FIGS. 2 to 4) are collectively covered, and conductive grounded parts 33b to 38b formed on each of the shielding member bodies 33a to 38a.

As the shielding member bodies 33a to 38a, conductive pipes 33c to 38c are used in the embodiment. The conductive pipes 33c to 38c are formed in tubular members for electromagnetic shielding (shielding members for measures against electromagnetic waves). Also, the conductive pipes 33c to 38c are formed in the length and the size (diameter) in which predetermined ranges of the two high-voltage electric wires 19 (see FIGS. 2 to 4) can be covered. The conductive pipes 33c to 38c are formed of metal pipes having conductivity or resin pipes having conductivity. In addition, the resin pipe herein is molded by extruding a conductive resin composition in which a conductive material is mixed with a resin material in a pipe shape.

The grounded parts 33b to 38b are electrically connected and fixed in predetermined positions of the shielding member bodies 33a to 38a. (In the embodiment, two places of one end side and the other end side of each of the shielding member bodies 33a to 38a correspond to the predetermined positions. In addition, the predetermined positions are not limited to the two places.) Such grounded parts 33b to 38b are electrically connected to a wire harness cabling target having conductivity and are formed as the portions capable of, for example, body earth.

Shapes etc. of the grounded parts 33b to 38b are not particularly limited as long as the body earth is enabled. For example, a publicly known earth wire or a member such as a conductive damp 54 (see FIG. 6) described below may be used.

The plural conductive pipe shielding members 33 to 38 have a configuration and structure in which these members 33 to 38 are basically the same.

In FIG. 2, the conductive pipe shielding member 33 nearest to the first distal end 21 is configured to include the shielding member body 33a and the grounded part 33b. The shielding member body 33a has the conductive pipe 33c, and obtains a state in which the above tape winding portion of the other end of the braid 26c is inserted into one end of this shielding member body 33a and one end of the shielding member body 33a is lapped on the tape winding portion (not shown, but the same applies to the other end side).

In FIGS. 1A, 1B and 3, the conductive pipe shielding members 34 to 37 (a typical example is shown as, for example, the conductive pipe shielding members 35, 36 in FIG. 3) corresponding to the intermediate part 22 are configured to include the shielding member bodies 34a to 37a and the grounded parts 34b to 37b. The shielding member bodies 34a to 37a have the conductive pipes 34c to 37c, and obtain a state in which the above tape winding portions of one end and the other end of the braids 27c to 31c are inserted into one end and the other end of the shielding member bodies 34a to 37a (conductive pipes 34c to 37c) and one end and the other end of the shielding member bodies 34a to 37a are lapped on the tape winding portions.

In FIG. 4, the conductive pipe shielding member 38 nearest to the second distal end 23 is configured to include the shielding member body 38a and the grounded part 38b. The shielding member body 38a has the conductive pipe 38c, and obtains a state in which the above tape winding portion of one end of the braid 32c is inserted into the other end of this shielding member body 38a and the other end of the shielding member body 38a is lapped on the tape winding portion (not shown, but the same applies to one end side).

As described above with reference to FIGS. 1A to 4, the shielding member 20 with which the two high-voltage electric wires 19 are covered is divided into the plural pieces in the cabling direction of the wire harness 9. That is, the shielding member 20 is divided into the plural pieces so as to have the plural braid shielding members 26 to 32 and the plural conductive pipe shielding members 33 to 38. Also, the shielding member 20 has the grounded parts 26b to 32b and the grounded parts 33b to 38b in each of the braid shielding members 26 to 32 and the conductive pipe shielding members 33 to 38 divided into the plural pieces.

In manufacture of the wire harness 9, the shielding member 20 is divided and is not in a singly long state, so that it becomes easier to manufacture the wire harness than ever before. Also, the shielding member 20 is divided and is not in the singly long state, so that it becomes easy to handle the wire harness at the time of manufacture. Moreover, the grounded parts 26b to 32b and the grounded parts 33b to 38b are provided in each of the braid shielding members 26 to 32 and the conductive pipe shielding members 33 to 38 divided into the plural pieces, so that a shielding function can be fulfilled independently even in a divided state.

Therefore, the invention has an effect capable of improving more manufacturability or handleability for manufacture of the wire harness 9 than ever before.

### Second Embodiment

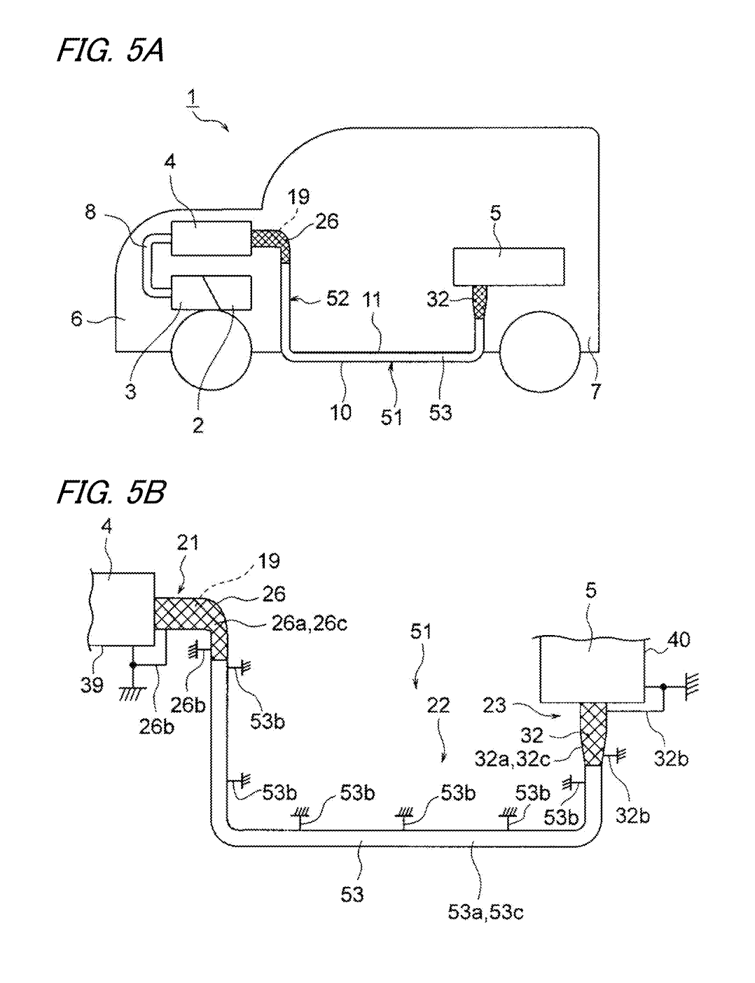

A second embodiment will hereinafter be described with reference to the drawings. FIGS. 5A and 5B are diagrams according to another example of a wire harness of the invention, and FIG. 5A is a schematic diagram of a vehicle, and FIG. 5B is a schematic diagram of the wire harness. Also, FIG. 6 is a perspective view according to a state of attachment of a clamp formed as combination with a grounded part. In addition, detailed description is omitted by assigning the same numerals to the same components as those of the first embodiment.

In FIGS. 5A and 5B, the second embodiment is the same as the first embodiment except that the wire harness 9 of the first embodiment is changed with a wire harness 51 described below. Therefore, the wire harness 51 will be described.

The wire harness 51 is means for electrically connecting an inverter unit 4 to a battery 5, and is configured to include two high-voltage electric wires 19 (see FIGS. 2 to 4), and a shielding member 52 with which the two high-voltage electric wires 19 are collectively covered, the shielding member 52 for shielding the high-voltage electric wires. The shielding member 52 is a characteristic member of the invention, and is configured to be divided into plural pieces in a cabling direction of the wire harness 51. Also, in the shielding member 52, each of the divided pieces has an independent shielding function.

The shielding member 52 is divided into the plural pieces as described above. Concretely, the shielding member 52 is divided into the plural pieces so as to have two braid shielding members 26 and 32 and a conductive pipe shielding member 53 disposed therebetween. The two braid shielding members 26 and 32 are disposed in positions corresponding to a first distal end 21 and a second distal end 23 like the first embodiment. The two braid shielding members 26 and 32 are similar to those of the first embodiment.

The conductive pipe shielding member 53 is configured to include a shielding member body 53a with which the two high-voltage electric wires 19 (see FIGS. 2 to 4) are collectively covered, and plural conductive grounded parts 53b formed on this one shielding member body 53a.

As the shielding member body 53a, a conductive pipe 53c is used in the embodiment. The conductive pipe 53c is formed in a tubular member for electromagnetic shielding (a shielding member for measures against electromagnetic waves). Also, the conductive pipe 53c is formed in the length and the size (diameter) in which predetermined ranges of the two high-voltage electric wires 19 (see FIGS. 2 to 4) can be covered. In the embodiment, the conductive pipe 53c is formed of a metal pipe having conductivity (may be formed of a resin pipe having conductivity).

The plural grounded parts 53b are electrically connected and fixed in predetermined positions of the shielding member body 53a. In the embodiment, the predetermined positions are disposed so as to correspond to fixed positions of the wire harness 51. The grounded part 53b is electrically connected to a wire harness cabling target (for example, a vehicle body underfloor part 15) having conductivity and is formed as the portion capable of, for example, body earth. In the embodiment, the grounded part 53b is combined with a conductive clamp 54 (see FIG. 6).

In FIG. 6, the damp 54 is a fixing member used in the case of fixing the wire harness 51 and is combined with the grounded part 53b as described above, so that, for example, when the damp 54 is fixed to the vehicle body underfloor part 15, grounding is completed simultaneously.

As described above with reference to FIGS. 5A, 5B and 6, the shielding member 52 is configured to be divided into the plural pieces in the cabling direction of the wire harness 51 in the second embodiment. Also, each of the divided pieces of the shielding member 52 has an independent shielding function. Therefore, the second embodiment naturally has an effect similar to that of the first embodiment.

That is, in manufacture of the wire harness 51, the shielding member 52 is divided and is not in a singly long state, so that it becomes easier to manufacture the wire harness than ever before. Also, the shielding member 52 is divided and is not in the singly long state, so that it becomes easy to handle the wire harness at the time of manufacture. Moreover, grounded parts 26b, 32b and the grounded part 53b are provided in each of the braid shielding members 26, 32 and the conductive pipe shielding member 53 divided into the plural pieces, so that a shielding function can be fulfilled independently even in a divided state.

Therefore, the invention has an effect capable of improving more manufacturability or handleability for manufacture of the wire harness 51 than ever before.

### Third Embodiment

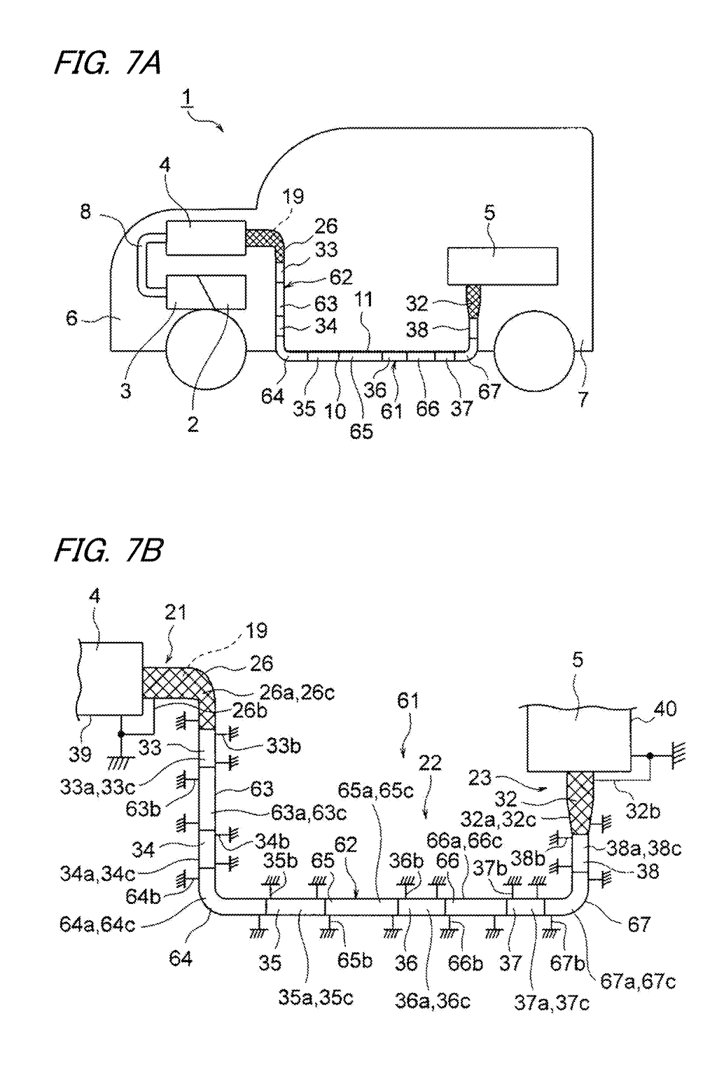

A third embodiment will hereinafter be described with reference to the drawings. FIGS. 7A and 7B are diagram according to a further example of a wire harness of the invention, and FIG. 7A is a schematic diagram of a vehicle, and FIG. 7B is a schematic diagram of the wire harness. In addition, detailed description is omitted by assigning the same numerals to the same components as those of the first and second embodiments.

In FIGS. 7A and 7B, the third embodiment is the same as the first embodiment except that the wire harness 9 of the first embodiment is changed with a wire harness 61 described below. Therefore, the wire harness 61 will be described.

The wire harness 61 is means for electrically connecting an inverter unit 4 to a battery 5, and is configured to include two high-voltage electric wires 19 (see FIGS. 2 to 4), and a shielding member 62 with which the two high-voltage electric wires 19 are collectively covered, the shielding member 62 for shielding the high-voltage electric wires. The shielding member 62 is a characteristic member of the invention, and is configured to be divided into plural pieces in a cabling direction of the wire harness 61. Also, in the shielding member 62, each of the divided pieces has an independent shielding function.

The shielding member 62 is divided into the plural pieces as described above. Concretely, the shielding member 62 is divided into the plural pieces so as to have two braid shielding members 26 and 32, plural metal foil shielding members 63 to 67, and plural conductive pipe shielding members 33 to 38. In addition, the number of plural metal foil shielding members 63 to 67 and the number of plural conductive pipe shielding members 33 to 38 in FIG. 7B are shown as one example.

The two braid shielding members 26 and 32 and the plural conductive pipe shielding members 33 to 38 are disposed in positions corresponding to a first distal end 21 and a second distal end 23 and a position corresponding to an intermediate part 22 like the first embodiment. The two braid shielding members 26 and 32 and the plural conductive pipe shielding members 33 to 38 are similar to those of the first embodiment.

The plural metal foil shielding members 63 to 67 are formed as alternatives to the braid shielding members 27 to 31 (see FIGS. 1A and 1B) of the first embodiment. The plural metal foil shielding members 63 to 67 are configured to include shielding member bodies 63a to 67a with which the two high-voltage electric wires 19 (see FIGS. 2 to 4) are collectively covered, and conductive grounded parts 63b to 67b formed on each of the shielding member bodies 63a to 67a.

As the shielding member bodies 63a to 67a, metal foils 63c to 67c are used in the embodiment. The metal foils 63c to 67c are publicly known copper foil, aluminum foil, iron foil, etc., and metal foil formed by integrating a metal foil single body or a resin film such as PET is adopted.

As described above with reference to FIGS. 7A and 7B, the shielding member 62 is configured to be divided into the plural pieces in the cabling direction of the wire harness 61 in the third embodiment. Also, each of the divided pieces of the shielding member 62 has an independent shielding function. Therefore, the third embodiment naturally has an effect similar to that of the first embodiment. That is, the invention has an effect capable of having better manufacturability or handleability for manufacture of the wire harness 61 than ever before.

It is apparent that various modifications can be made in the invention within a scope not deviating from the gist of the invention.

The present application is based on Japanese patent application No. 2011-241945 filed on Nov. 4, 2011, and the contents of the patent application are incorporated herein by reference.

### INDUSTRIAL APPLICABILITY

The present invention is useful for providing a wire harness capable of improving manufacturability and handleability.

### REFERENCE SIGNS LIST

1 . . . HYBRID VEHICLE
2 . . . ENGINE
3 . . . MOTOR UNIT
4 . . . INVERTER UNIT
5 . . . BATTERY
6 . . . ENGINE ROOM
7 . . . VEHICLE REAR PART
8 . . . HIGH-VOLTAGE WIRE HARNESS
9 . . . WIRE HARNESS
10 . . . INTERMEDIATE PART
11 . . . VEHICLE BODY UNDERFLOOR PART
19 . . . HIGH-VOLTAGE ELECTRIC WIRE (CONDUCTING PATH)
20 . . . SHIELDING MEMBER
21 . . . FIRST DISTAL END
22 . . . INTERMEDIATE PART
23 . . . SECOND DISTAL END
24 . . . INSULATOR
25 . . . TERMINAL FITTING
26-32 . . . BRAID SHIELDING MEMBER
26a-32a . . . SHIELDING MEMBER BODY
26b-32b . . . GROUNDED PART
26c-32c . . . BRAID
26d,32d . . . SHIELD SHELL
33-38 . . . CONDUCTIVE PIPE SHIELDING MEMBER
33a-38a . . . SHIELDING MEMBER BODY
33b-38b . . . GROUNDED PART
33c-38c . . . CONDUCTIVE PIPE
39,40 . . . SHIELD CASE
51 . . . WIRE HARNESS
52 . . . SHIELDING MEMBER
53 . . . CONDUCTIVE PIPE SHIELDING MEMBER
53a . . . SHIELDING MEMBER BODY
53b . . . GROUNDED PART
53c . . . CONDUCTIVE PIPE
54 . . . CLAMP (FIXING MEMBER)
61 . . . WIRE HARNESS
62 . . . SHIELDING MEMBER
63-67 . . . METAL FOIL SHIELDING MEMBER
63a-67a . . . SHIELDING MEMBER BODY
63b-67b . . . GROUNDED PART
63c-67c . . . METAL FOIL

1. A wire harness including one or plural conducting paths, and a shielding member with which said one or plural conducting paths are covered, the shielding member divided into plural pieces in a cabling direction, wherein
each of the plural pieces in the shielding member has a grounded part.

2. A wire harness as claimed in claim 1, wherein the shielding member divided into the plural pieces includes a shielding member made of a braid or metal foil, and a shielding member made of a conductive pipe, and
the shield member made of the conductive pipe has a fixing member for fixing the shielding member made of the conductive pipe to a conductive wire harness cabling target, the fixing member being combined with the grounded part.

3. A wire harness as claimed in claim 2, wherein the shielding member made of the braid or the metal foil and the shielding member made of the conductive pipe are arranged with ends of the shielding member made of the braid or the metal foil and the shielding member made of the conductive pipe lapped mutually.
